(19) United States
(12) Patent Application Publication
(10) Pub. No.: US 2025/0236704 A1
(43) Pub. Date: Jul. 24, 2025

(54) SKELETON SUPPORTED CATALYST AND METHOD FOR PREPARING ALLYL ALCOHOL POLYOXYETHYLENE ETHER BY USING THE SAME

(71) Applicants: Zhejiang Huangma Technology Co., Ltd., Shaoxing (CN); Zhejiang Huangma Shangyi New Material Co., Ltd., Shaoxing (CN); Zhejiang Lukean Chemical Co., Ltd., Shaoxing (CN); ZHEJIANG HUANGMA CHEMICAL NEW POLYMER MATERIAL CO., LTD, Shaoxing (CN)

(72) Inventors: Weisong Wang, Shaoxing (CN); Dinglian Ma, Shaoxing (CN); Yifeng Jin, Shaoxing (CN); Majishi Wang, Shaoxing (CN)

(21) Appl. No.: 18/749,649

(22) Filed: Jun. 21, 2024

(30) Foreign Application Priority Data
Jan. 18, 2024 (CN) 202410071518.8

(51) Int. Cl. C08G 65/26

(52) U.S. Cl. CPC C08G 65/2693; C08G 65/2609

(57) ABSTRACT

The present disclosure herein discloses a skeleton supported catalyst and a method for preparing allyl alcohol polyoxyethylene ether by using the same. The skeleton supported catalyst is a catalyst loaded with barium oxide, potassium oxide, yttrium oxide within a copper skeleton. A method comprising: putting the skeleton supported catalyst into a reaction vessel, and after adding nitrogen to the reaction vessel, adding dried and dehydrated allyl alcohol or the allyl alcohol polyoxyethylene ether with low molecular weight to the reaction vessel, raising the temperature, and continuously introducing dried and dehydrated ethylene oxide for reaction; after the reaction being completed, cooling down, and filtering and discharging to obtain after the reaction being completed, cooling down, and filtering and discharging to obtain a finished product of the allyl alcohol polyoxyethylene ether. The allyl alcohol polyoxyethylene ether product prepared by the skeleton supported catalyst of the present disclosure has excellent product performance.

### CROSS-REFERENCE TO RELATED APPLICATION

The present application claims priority from Chinese Patent Application No. 202410071518.8 filed on Jan. 18, 2024, the contents of which are incorporated herein by reference in their entirety.

### TECHNICAL FIELD

The present disclosure herein relates to the technical field of organic polymer compound synthesis, and in particular to a skeleton supported catalyst and a method for preparing allyl alcohol polyoxyethylene ether by using the same thereof.

### BACKGROUND

Allyl alcohol polyoxyethylene ether is an allyl alcohol derivative synthesized by the reaction of allyl alcohol with ethylene oxide (EO) in the presence of a catalyst; due to the double bond in its structure, it can undergo a grafting reaction with hydrogen-containing silicone oil under the action of a platinum catalyst to produce a polyether-modified silicone oil with high surface activity. Polyether-modified silicone oil is widely used in coating wetting agents and leveling agents, pesticide synergists, printing and dyeing wetting agents, papermaking defoaming agents, water reducers and other fields, and has broad development prospects.

The double bond retention rate of allyl alcohol polyoxyethylene ether and the content of bishydroxy polyether byproducts are the key to measuring the quality of allyl alcohol polyoxyethylene ether. High-quality polyether-modified silicone oil must be based on high double bond retention rate and low content of bishydroxy polyether byproduct allyl alcohol polyoxyethylene ether. The double bond retention rate of allyl alcohol polyoxyethylene ether and the content of byproduct bishydroxy polyether are key factors affecting the performance and product quality of polyether-modified silicone oil. At present, there have been some reports on the synthesis methods of allyl alcohol polyoxyethylene ether. For example, Guolong Guo et al. published “Preparation of Allyl Alcohol Polyoxyethylene Ether with DMC Catalyst and Study on Its Application Performance” in the journal “Daily Chemicals Science”. The article used a double metal cyanide complex catalyst (DMC) prepared from ZnCl₂ and K₃Co(CN)₆ to catalyze the ethoxylation reaction to synthesize allyl alcohol polyoxyethylene ether, and the byproduct polyethylene glycol content reached 1.78%. Patent CN201310222073.0 discloses a preparation method of polycarboxylate water-reducing agent macromonomer methylallyl alcohol polyoxyethylene ether. The method uses methylallyl alcohol as an initiator and boron trifluoride-ether as a catalyst to react with 5-10 mol of ethylene oxide for addition reaction, and then uses a hydrogen oxidizing agent, sodium hydroxide or sodium methoxide as a catalyst to synthesize a crude product with a higher molecular weight, and then adds glacial acetic acid or the like to neutralize the reaction solution to obtain a finished product. The method has the following problems: 1. Boron trifluoride-ether is used as a catalyst, and boron trifluoride-ether is easy to cause ethylene oxide to self-polymerize to generate dioxane and polyethylene glycol as byproducts, resulting in an increase in the content of byproducts, affecting the performance of the product; 2. Acid is used for direct neutralization, but metal ions such as K and Na in the product are not removed, so that the obtained methyl allyl alcohol polyoxyethylene ether cannot be used in the synthesis of polyether-modified silicone oil. This is because the K and Na metal ions in the system will cause the chloroplatinic acid platinum catalyst to be deactivated. Patent CN201410157740.6 uses the intermediate product obtained by the reaction of methyl allyl alcohol and lithium aluminum tetrahydride as a catalyst, uses methyl allyl alcohol as an initiator, adds ethylene oxide to react to obtain methyl allyl alcohol oligomers, then uses alkaline catalysts such as KOH, adds ethylene oxide to react to obtain a crude methyl allyl alcohol polyoxyethylene ether, and adds glacial acetic acid to directly neutralize to obtain a finished product. This method also has the problem of multiple metal ions such as K, Na, aluminum, and lithium remaining in the product, so that the obtained methyl allyl alcohol polyoxyethylene ether cannot be used in the synthesis of polyether modified silicone oils. In addition, due to the presence of multiple metal ions, the use of acid neutralization and crystallization adsorption has the problems of different solubility of various metal salts, difficult to control crystallization and incompleteness. Patent CN202010754807.X discloses a preparation method of polycarboxylate water-reducing agent macromonomer methylallyl alcohol polyoxyethylene ether. Methyl allyl alcohol is used as an initiator and sodium hydride is used as a catalyst to synthesize a crude product of methyl allyl alcohol polyoxyethylene ether, and then glacial acetic acid is added for direct neutralization to obtain a finished product. This process also has the problem of using acid neutralization without removing metal ions such as K and Na, which will cause the deactivation of the platinum chloroplatinic acid catalyst and make the finished product unable to be used in polyether modified silicone oil. Patent CN200910198310.8 discloses a method for preparing allyl alcohol polyoxyethylene ether, which uses allyl alcohol as a raw material and sodium allyl alcohol or potassium allyl alcohol as a catalyst to react with ethylene oxide for addition reaction. After the reaction is completed, glacial acetic acid is added for neutralization. After cooling, the methyl allyl alcohol polyoxyethylene ether is directly filtered with a liquid filter bag with an accuracy of 35-75 μm to obtain the finished product. This method is just a simple neutralization+direct filtration, which will leave a large amount of metal K and Na ions (>150 ppm), resulting in the product being unable to be used in the synthesis of polyether modified silicone oil and causing the problem of deactivation of chloroplatinic acid platinum catalyst.

It can be seen that the synthesis method of allyl alcohol polyoxyethylene ether provided by the existing technology mainly has the following shortcomings: first, the trace moisture carried by the raw materials ethylene oxide and allyl alcohol themselves is not taken into account (the commercially available ethylene oxide contains about 0.02% moisture, and the commercially available allyl alcohol contains about 0.03% moisture), and the moisture carried by these raw materials themselves is not removed. Instead, the allyl alcohol polyoxyethylene ether is directly synthesized by them. In the presence of a catalyst, the moisture will react with ethylene oxide to generate a byproduct polyethylene glycol, resulting in a high byproduct content (allyl alcohol polyoxyethylene ether molecular weight 500, polyethylene glycol content>0.4%, allyl alcohol polyoxyethylene ether molecular weight 1000, polyethylene glycol content>1.0%), while the product has a low content of effective ingredients and a wide molecular weight distribution, thereby affecting product performance; second, conventional catalysts such as KOH, sodium allyl alcohol or potassium allyl alcohol are used, and metal ions such as K and Na are not removed in the post-treatment, so that the obtained allyl alcohol polyoxyethylene ether cannot be used in the synthesis of polyether-modified silicone oil.

Therefore, it is necessary to develop a skeleton supported catalyst and a method for preparing allyl alcohol polyoxyethylene ether using the same, so as to solve the problems of high byproduct polyethylene glycol content, wide molecular weight distribution and high metal ion content in the existing synthesis method, and to enable allyl alcohol polyoxyethylene ether products to be used in the synthesis of polyether-modified silicone oils in the fields of high-end coatings and the like.

### SUMMARY

In order to overcome the shortcomings of the prior art, one of the purposes of the present disclosure is to provide a skeleton supported catalyst, which has a porous structure, a large specific surface area, high catalytic activity, good selectivity, and a product synthesized by the catalyst has a narrow molecular weight distribution and can be recycled.

To solve the above problems, the technical solution adopted by the present disclosure is as follows:
the skeleton supported catalyst is a catalyst loaded with barium oxide, potassium oxide, and yttrium oxide within a copper skeleton; wherein, a weight percentage of the copper skeleton in the skeleton supported catalyst is 70-90%, and a ratio of amount of barium, potassium, and yttrium elements is 1:0.02-0.08:0.01-0.04.

The second object of the present disclosure is to provide a method for preparing the skeleton supported catalyst as described above, comprising:
Step A: activating aluminum copper alloy in potassium hydroxide solution for 20-28 hours to dissolve aluminum in the potassium hydroxide solution, then filtering and washing to obtain the copper skeleton;
Step B: putting the copper skeleton into a barium hydroxide aqueous solution at 60-70° C., slowly stirring and cooling to 35-45° C., causing the barium hydroxide to supersaturate and precipitate, filtering copper skeleton particles with barium hydroxide precipitate, and calcining the copper skeleton particles at 700-800° C. for 2-4 hours to obtain the copper skeleton loaded with barium oxide;
Step C: immersing or pouring the copper skeleton loaded with barium oxide in a mixed solution containing the potassium hydroxide and yttrium nitrate for 2-5 minutes, after filtration, calcining the copper skeleton at 400-500° C. for 2-4 hours, after cooling, obtaining the skeleton supported catalyst loaded with the barium oxide, the potassium oxide, and the yttrium oxide.

In the above preparation method, in Step A, a weight ratio of copper to aluminum in the aluminum copper alloy is 1:2-4; a mass concentration of the potassium hydroxide solution is 25-35%.

As a preferred embodiment of the present disclosure, particle sizes of the aluminum copper alloy in step A and the copper skeleton particles in Step B are both 200-1000 μm.

As a preferred embodiment of the present disclosure, in Step B, a mass concentration of the barium hydroxide aqueous solution is 15-20%.

As a preferred embodiment of the present disclosure, in Step C, a mass concentration of the potassium hydroxide in the mixed solution is 20-30%, and a mass concentration of the yttrium nitrate is 20-30%.

The third object of the present disclosure is to provide the use of the skeleton supported catalyst as described above or the skeleton supported catalyst prepared by the preparation method as described above in the preparation of allyl alcohol polyoxyethylene ether.

A fourth object of the present disclosure is to provide a method for preparing allyl alcohol polyoxyethylene ether using the skeleton supported catalyst as described above or the skeleton supported catalyst prepared by the preparation method as described above. The method has simple steps and is easy to control. The allyl alcohol polyoxyethylene ether product prepared by the method has low byproduct content, high effective component content, narrow molecular weight distribution, and excellent product performance.

A method for preparing allyl alcohol polyoxyethylene ether using the skeleton supported catalyst specifically comprising:
Step 1: putting the skeleton supported catalyst into a reaction vessel, and after adding nitrogen to the reaction vessel, adding dried and dehydrated allyl alcohol or the allyl alcohol polyoxyethylene ether with molecular weight 100-600 to the reaction vessel, raising the temperature, and continuously introducing dried and dehydrated ethylene oxide for reaction; and
Step 2: after the reaction being completed, cooling down, and filtering and discharging to obtain a finished product of the allyl alcohol polyoxyethylene ether.

As a preferred embodiment of the present disclosure, in Step S1, dosage of the skeleton supported catalyst is 0.5-3.0% of a sum of mass of the allyl alcohol or the allyl alcohol polyoxyethylene ether and the ethylene oxide.

As a preferred embodiment of the present disclosure, in Step S1, a weight ratio of the allyl alcohol or the allyl alcohol polyoxyethylene ether to the ethylene oxide is 1:0.75-68.

As a preferred embodiment of the present disclosure, in Step S1, reaction temperature for adding the ethylene oxide is 90-140° C.

As a preferred embodiment of the present disclosure, in Step S2, after cooling to 55-75° C., filter and discharge.

As a preferred embodiment of the present disclosure, a molecular weight of a finished product of the allyl alcohol polyoxyethylene ether is 100-4000; byproduct polyethylene glycol content in the finished product of the allyl alcohol polyoxyethylene ether is ≤0.3%, and Na⁺ and K⁺ content is ≤2 ppm.

Compared with the prior art, the present disclosure has the following beneficial effects:
1. the skeleton supported catalyst of the present disclosure has a porous structure, a large specific surface area, high catalytic activity and good selectivity. When applied to the synthesis of allyl alcohol polyoxyethylene ether, it will not react with allyl alcohol to produce a polyethylene glycol byproduct containing a dihydroxyl group. Wherein barium oxide plays a main catalytic role and has good catalytic selectivity; loading yttrium oxide and potassium oxide on the copper skeleton catalyst loaded with barium oxide can not only accelerate the reaction speed, but also ensure that a product with a narrow molecular weight distribution is obtained. This is due to the synergistic effect of the high reactivity of potassium oxide and yttrium oxide. The synthesized allyl alcohol polyoxyethylene ether product has the advantage of a narrow molecular weight distribution. Meanwhile, the skeleton supported catalyst is a solid catalyst, which is easy to separate and recycle.
2. the preparation method of the skeleton supported catalyst provided by the present disclosure has low preparation cost, is recyclable, is environmentally friendly, simple to operate, and has high process stability. The prepared catalyst has high catalytic activity by being loaded with a variety of metal ions.
3. the present disclosure adopts a skeleton supported catalyst to catalyze the reaction of allyl alcohol and ethylene oxide. The catalyst will not react with allyl alcohol to produce a polyethylene glycol byproduct containing a dihydroxyl group, thus effectively avoiding the reaction of conventional catalysts such as KOH with allyl alcohol to produce water, which in turn reacts with ethylene oxide to produce a byproduct polyethylene glycol, thereby reducing the effective ingredients of the product and affecting the product performance. At the same time, since the metal ions in the skeleton supported catalyst are insoluble in the product, the metal ion content in the product is ≤2 ppm, thus effectively avoiding the problem of direct neutralization with acid in the conventional method and the problem that the product cannot react with hydrogen-containing silicone oil without completely removing the metal ions. The obtained allyl alcohol polyoxyethylene ether product can be applied to a system in which a trace amount of platinum catalyst reacts with hydrogen-containing silicone oil to synthesize polyether-modified silicone oil. The skeleton supported catalyst is easy to recover and reuse. In addition, the present disclosure dries and removes water from the reaction raw materials allyl alcohol and ethylene oxide, which effectively avoids the problem of residual water in the reaction raw materials reacting with ethylene oxide to produce byproduct polyethylene glycol, and further reduces the byproduct content in the product.
4. the allyl alcohol polyoxyethylene ether prepared by the preparation method of the present disclosure has greatly reduced byproduct content, high content of effective ingredients, narrow molecular weight distribution, low content of metal ions such as K and Na, and excellent product performance, so that it can be used in the synthesis of polyether modified silicone oils in the fields of high-end coatings.

### BRIEF DESCRIPTION OF THE DRAWINGS

FIG. 1 is a comparison diagram of the finished polyether-modified silicone oils prepared using the allyl alcohol polyoxyethylene ether prepared in Example 1 of the present disclosure and Comparative Example 1;

FIG. 2 is a comparison diagram of the finished polyether-modified silicone oils prepared using the allyl alcohol polyoxyethylene ethers prepared in Example 2, Comparative Example 2 and Comparative Example 5 of the present disclosure;

FIG. 3 is a comparison diagram of the finished polyether-modified silicone oils prepared using the allyl alcohol polyoxyethylene ethers prepared in Example 3, Comparative Example 3 and Comparative Example 6 of the present disclosure;

FIG. 4 is a comparison diagram of the finished polyether-modified silicone oils prepared using the allyl alcohol polyoxyethylene ether prepared in Example 4 of the present disclosure and Comparative Example 4, respectively.

### DETAILED DESCRIPTION OF THE EMBODIMENTS

The method for preparing allyl alcohol polyoxyethylene ether using a skeleton supported catalyst provided by the present disclosure, comprising:
Step 1: putting the skeleton supported catalyst into a reaction vessel, and after adding nitrogen to the reaction vessel, adding dried and dehydrated allyl alcohol, after heating to 90-140° C., continue to introduce the dried and dehydrated ethylene oxide to react at 90-140° C.; wherein, dosage of the skeleton supported catalyst is 0.5-3.0% of a sum of mass of the allyl alcohol and the ethylene oxide, a weight ratio of the allyl alcohol and the ethylene oxide is 1:0.75-68; the reaction equation of the above reaction is as follows:

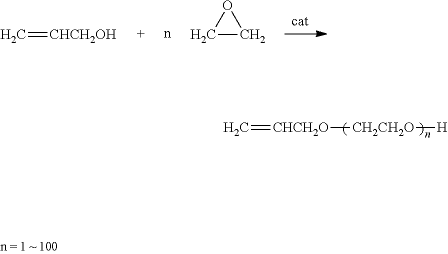

Step 2: after the reaction being completed, the temperature is lowered to 55-75° C., filtering and discharging to obtain a finished product of the allyl alcohol polyoxyethylene ether.

A molecular weight of a finished product of the allyl alcohol polyoxyethylene ether prepared by the preparation method is 100-4000; byproduct polyethylene glycol content in the finished product of the allyl alcohol polyoxyethylene ether is ≤0.3%, and Na⁺ and K⁺ content is ≤2 ppm.

In the above preparation method, the skeleton supported catalyst is a catalyst loaded with barium oxide, potassium oxide, and yttrium oxide within a copper skeleton; wherein, a weight percentage of the copper skeleton in the skeleton supported catalyst is 70-90%, and a ratio of amount of barium, potassium, and yttrium elements is 1:0.02-0.08:0.01-0.04. The preparation method of the skeleton supported catalyst, comprising:
Step A: activating aluminum copper alloy with a particle size of 200-1000 μm and a weight ratio of copper to aluminum of 1:2-4 in potassium hydroxide solution with a mass concentration of 25-35% for 20-28 hours to dissolve aluminum in the potassium hydroxide solution, then filtering and washing to obtain the copper skeleton;
Step B: putting the copper skeleton into a barium hydroxide aqueous solution with a mass concentration of 15-20% at 60-70° C., slowly stirring and cooling to 35-45° C., causing the barium hydroxide to supersaturate and precipitate, filtering and screening out copper skeleton particles with a particle size of 200-1000 μm and with barium hydroxide precipitate, and calcining the copper skeleton particles at 700-800° C. for 2-4 hours to obtain the copper skeleton loaded with barium oxide;
Step C: immersing or pouring the copper skeleton loaded with barium oxide in a mixed solution containing the potassium hydroxide with a mass concentration of 20-30% and yttrium nitrate with a mass concentration of 20-30% for 2-5 minutes, after the time is up, filter immediately, calcining the copper skeleton at 400-500° C. for 2-4 hours, after cooling and sealing, a skeleton supported catalyst loaded with the barium oxide, the potassium oxide, and the yttrium oxide is obtained.

The present disclosure is further described in detail below in conjunction with specific implementation modes.

Preparation of the reaction vessel before implementation: cleaning, blowing and drying the pipelines for transporting the reaction raw materials until they are clean and dry; drying the reaction vessel and cooling it to room temperature for use. The following examples are used to illustrate the present disclosure, but are not intended to limit the scope of this patent. The molecular weight mentioned in the examples and comparative examples is Mn (number average molecular weight, measured by gel permeation chromatography GPC), the molecular weight distribution coefficient D (measured by gel permeation chromatography GPC), and the polyethylene glycol (PEG) content is measured by liquid chromatography. The surface tension mentioned in the application experiment is measured using the national standard GB/T 5549-2010 method, and the wetting time (penetration force) is measured using the national standard GB/T 11983-2008 method.

Preparation of skeleton supported catalyst: activating 500 g of aluminum copper alloy with a particle size of 200-1000 μm and a weight ratio of copper to aluminum of 1:3 in 5 L of potassium hydroxide solution with a mass concentration of 30% for 24 hours to dissolve aluminum in the alkali solution, then filtering and washing to obtain the copper skeleton; putting the copper skeleton into 3 L of barium hydroxide aqueous solution with a mass concentration of 17% at 65° C., slowly stirring and cooling to 40° C., causing the barium hydroxide to supersaturate and precipitate slowly, filtering and screening out copper skeleton particles with a particle size of 200-1000 μm and with barium hydroxide precipitate, and calcining the copper skeleton particles at 700-800° C. for 3 hours to obtain the copper skeleton loaded with barium oxide; then immersing the copper skeleton in a mixed solution containing the potassium hydroxide with a mass concentration of 25% and yttrium nitrate with a mass concentration of 25% for 3 minutes, after the time is up, filter immediately, calcining the copper skeleton at 400-500° C. for 3 hours, after cooling and sealing, a skeleton supported catalyst loaded with the barium oxide, the potassium oxide, and the yttrium oxide is obtained.

### Example 1

The method for preparing allyl alcohol polyoxyethylene ether using the skeleton supported catalyst, comprising:
Step 1: putting 23.3 g of skeleton supported catalyst into a reaction vessel, after replacing the air in the reaction vessel three times with N₂, introduce 300 g of dried and dehydrated allyl alcohol into the reaction vessel, after the allyl alcohol is added, the temperature is raised to 90° C. and 1255 g of dried and dehydrated ethylene oxide is continuously added to react, the reaction temperature is controlled at 90-140° C., and after the addition is completed, the reaction is continued for 1 hour.
Step 2: after the reaction being completed, low boiling points are removed by vacuum pumping, cooling to 60° C., and filtering and discharging to obtain a finished product of the allyl alcohol polyoxyethylene ether.

### Example 2

The method for preparing allyl alcohol polyoxyethylene ether using the skeleton supported catalyst, comprising:
Step 1: putting 15.5 g of skeleton supported catalyst into a reaction vessel, after replacing the air in the reaction vessel three times with N₂, introduce 200 g of dried and dehydrated allyl alcohol into the reaction vessel, after the allyl alcohol is added, the temperature is raised to 90° C. and 1350 g of dried and dehydrated ethylene oxide is continuously added to react, the reaction temperature is controlled at 90-140° C., and after the addition is completed, the reaction is continued for 1 hour.
Step 2: after the reaction being completed, low boiling points are removed by vacuum pumping, cooling to 60° C., and filtering and discharging to obtain a finished product of the allyl alcohol polyoxyethylene ether.

### Example 3

The method for preparing allyl alcohol polyoxyethylene ether using the skeleton supported catalyst, comprising:
Step 1: putting 30 g of skeleton supported catalyst into a reaction vessel, after replacing the air in the reaction vessel three times with N2, introduce 300 g of dried and dehydrated allyl alcohol polyoxyethylene ether prepared in Example 1 into the reaction vessel, after the allyl alcohol polyoxyethylene is added, the temperature is raised to 90° C. and 1250 g of dried and dehydrated ethylene oxide is continuously added to react, the reaction temperature is controlled at 90-140° C., and after the addition is completed, the reaction is continued for 1 hour.
Step 2: after the reaction being completed, low boiling points are removed by vacuum pumping, cooling to 60° C., and filtering and discharging to obtain a finished product of the allyl alcohol polyoxyethylene ether.

### Example 4

The method for preparing allyl alcohol polyoxyethylene ether using the skeleton supported catalyst, comprising:
Step 1: putting 38 g of skeleton supported catalyst into a reaction vessel, after replacing the air in the reaction vessel three times with N2, introduce 200 g of dried and dehydrated allyl alcohol polyoxyethylene ether prepared in Example 1 into the reaction vessel, after the allyl alcohol polyoxyethylene is added, the temperature is raised to 90° C. and 1350 g of dried and dehydrated ethylene oxide is continuously added to react, the reaction temperature is controlled at 90-140° C., and after the addition is completed, the reaction is continued for 1 hour.
Step 2: after the reaction being completed, low boiling points are removed by vacuum pumping, cooling to 60° C., and filtering and discharging to obtain a finished product of the allyl alcohol polyoxyethylene ether.

### Comparative Example 1

Taking the preparation process disclosed in Chinese patent CN202010754807.X as Comparative Example 1, the specific steps are as follows:
putting 300 g of allyl alcohol that has not been dried and dehydrated into the reaction vessel directly where N₂ has been replaced, after the allyl alcohol is added, 0.75 g of sodium hydride is added to react, after the reaction being completed, the hydrogen produced by the reaction of allyl alcohol and metallic sodium is removed by vacuum, the temperature is raised to 90° C., and 1255 g of dried and dehydrated ethylene oxide is continuously added to react, and after the addition is completed, the reaction is continued for 1 hour. After the reaction being completed, low boiling points are removed by vacuum, and cooling to 70° C. to obtain a crude product of allyl alcohol polyoxyethylene ether. After 500 g of the crude product is released, 1.3 g of glacial acetic acid is added for neutralization to obtain allyl alcohol polyoxyethylene ether.

### Comparative Example 2

The difference between this Comparative Example and Comparative Example 1 is that the dosage of allyl alcohol is 200 g, the dosage of sodium hydride is 0.6 g, the dosage of ethylene oxide is 1350 g, the dosage of glacial acetic acid is 1.5 g, and the other process conditions are the same as those in Comparative Example 1.

### Comparative Example 3

The difference between this Comparative Example and Comparative Example 1 is that the reaction raw material is the crude product of allyl alcohol polyoxyethylene ether obtained in Comparative Example 1 and its dosage is 300 g, the dosage of sodium hydride is 0.5 g, the dosage of ethylene oxide is 1250 g, and the dosage of glacial acetic acid is 1.6 g, and the other process conditions are the same as those in low boiling points 1.

### Comparative Example 4

The difference between this Comparative Example and Comparative Example 1 is that the reaction raw material is the crude product of allyl alcohol polyoxyethylene ether obtained in Comparative Example 1 and its dosage is 200 g, the dosage of sodium hydride is 1.0 g, the dosage of ethylene oxide is 1350 g, and the dosage of glacial acetic acid is 2.7 g, and the other process conditions are the same as those in low boiling points 1.

### Comparative Example 5

Taking the preparation method disclosed in Chinese patent CN200910198310.8 as Comparative Example 5, the specific steps are as follows:

First, replace the air in the reaction vessel with nitrogen, add 196.7 g of allyl alcohol that has not been dried and dehydrated, and add 2.0 g of sodium allyl alcohol catalyst. Replace the air in the reaction vessel with nitrogen, start stirring, heat to the set reaction temperature, add 500 g of ethylene oxide that has not been dried and dehydrated for reaction, the reaction temperature is 90-110° C., after the reaction, cool to 60° C. and evacuate to remove unreacted ethylene oxide and low molecular weight substances, maintain the system pressure at −0.1˜−0.05 MPa, and maintain it for 30 min.

Start stirring and add 2.65 g of sodium allyl alcohol catalyst into the reaction vessel, then replace the gas in the reaction vessel with N₂. The temperature was raised to the set reaction temperature, introducing 854 g of ethylene oxide for reaction, and controlling the reaction pressure at 0-0.4 MPa. After the reaction being completed, 3.5 g of acetic acid is added to neutralize the product, and after cooling, the product is filtered using a liquid filter bag with an accuracy of 50 m to obtain the allyl polyoxyethylene ether product.

### Comparative Example 6

Taking the preparation method disclosed in Chinese patent CN200910198310.8 as Comparative Example 6, the specific steps are as follows:

First, replace the air in the reaction vessel with nitrogen, add 296.6 g of allyl alcohol that has not been dried and dehydrated, and add 4.7 g of sodium allyl alcohol catalyst. Replace the air in the reaction vessel with nitrogen, start stirring, heat to the set reaction temperature, add 1250 g of ethylene oxide that has not been dried and dehydrated for reaction, the reaction temperature is 90-110° C., after the reaction, cool to 60° C. and to release 1301 g of material.

Start stirring and add 1.5 g of sodium allyl alcohol catalyst into the reaction vessel, then replace the gas in the reaction vessel with N₂. The temperature was raised to the set reaction temperature, introducing 1050 g of ethylene oxide for reaction, and controlling the reaction pressure at 0-0.4 MPa. After the reaction being completed, 1.7 g of acetic acid is added to neutralize the product, and after cooling, the product is filtered using a liquid filter bag with an accuracy of 50 μm to obtain the allyl polyoxyethylene ether product.

### 1. Performance Comparison Experiment of Allyl Polyoxyethylene Ether

The finished allyl polyoxyethylene ethers obtained in Examples 1 to 4 and Comparative Examples 1 to 6 were respectively subjected to determination of byproduct polyethylene glycol content, Na⁺ and K⁺ content, number average molecular weight and molecular weight distribution, and the results are shown in Table 1.

TABLE 1
Performance comparison of allyl polyoxyethylene ethers in Examples 1 to 4 and Comparative Examples 1 to 6

| | Example | Example | Example | Example | Comparative | Comparative | Comparative | Comparative | Comparative | Comparative |
|---|---|---|---|---|---|---|---|---|---|---|
| Items | 1 | 2 | 3 | 4 | Example 1 | Example 2 | Example 3 | Example 4 | Example 5 | Example 6 |
| PEG (%) | 0.04 | 0.06 | 0.1 | 0.12 | 0.3 | 0.7 | 1.8 | 3.2 | 0.8 | 1.9 |
| Molecular | 300 | 449 | 1540 | 2300 | 291 | 416 | 1427 | 2080 | 428 | 1438 |
| weight Mn | | | | | | | | | | |
| Molecular | 1.01 | 1.01 | 1.02 | 1.03 | 1.03 | 1.06 | 1.09 | 1.11 | 1.05 | 1.09 |
| weight | | | | | | | | | | |
| distribution | | | | | | | | | | |
| D | | | | | | | | | | |
| Na⁺, K⁺ | 0.3 | 0.3 | 0.4 | 0.3 | 483 | 557 | 594 | 1003 | 252 | 243 |
| (ppm) | | | | | | | | | | |

It can be seen from the data in Table 1 that when the raw materials allyl alcohol and ethylene oxide are used in the same amount, the allyl alcohol polyoxyethylene ethers synthesized by the preparation method of the present disclosure in Examples 1 to 4 have a higher molecular weight (3 to 10% higher) than those in Comparative Examples 1 to 4, and a significantly narrower molecular weight distribution, while the byproduct polyethylene glycol content in Comparative Examples 1 to 4 is more than 10 times higher than that in the products of Examples 1 to 4. By comparing Examples 2-3 with Comparative Examples 5-6, it can be seen that when the ratio of allyl alcohol and ethylene oxide used as raw materials is the same (the molecular weight is designed to be the same), the allyl alcohol polyoxyethylene ether synthesized by the method of the present disclosure in Examples 2-3 has a higher molecular weight (5-7% higher) than that in Comparative Examples 5-6, and the molecular weight distribution is significantly narrower, while the content of byproduct polyethylene glycol in Comparative Examples 5-6 is more than 10 times higher than that in the products of Examples 2-3, which indicates that the quality of the product synthesized by the method of the present disclosure is significantly improved compared with the existing synthesis method.

### 2. Application Performance Test of Allyl Polyoxyethylene Ether

The finished allyl polyoxyethylene ethers obtained in Examples 1 to 4 and Comparative Examples 1 to 6 were applied to the synthesis of polyether-modified silicone oils, the specific synthesis method is as follows:

The reaction raw materials are the finished allyl polyoxyethylene ethers prepared in Examples 1 to 4 and Comparative Examples 1 to 6, hydrogen-containing silicone oil with a hydrogen content of 0.16%, and chloroplatinic acid ethanol solution with a mass concentration of 1%.

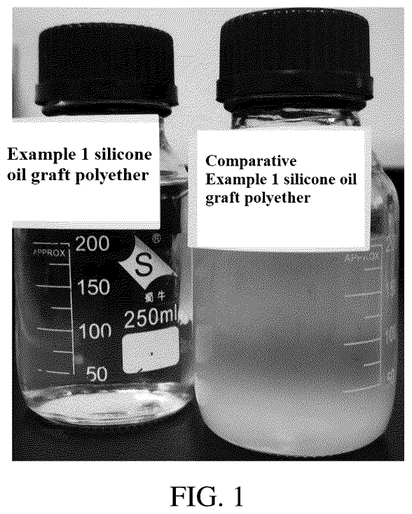

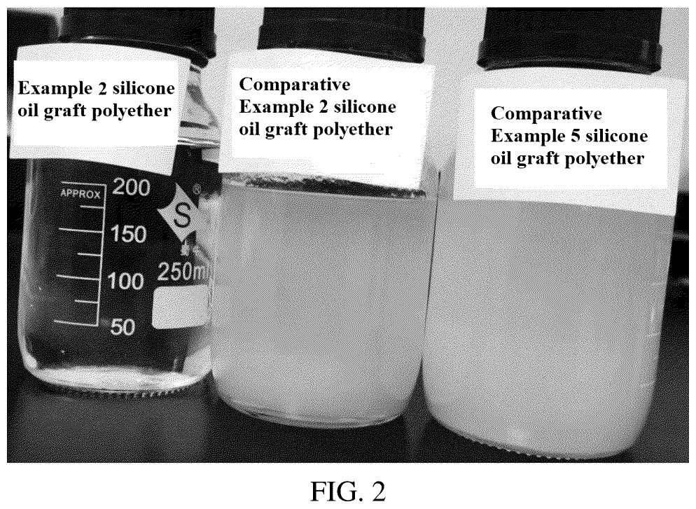

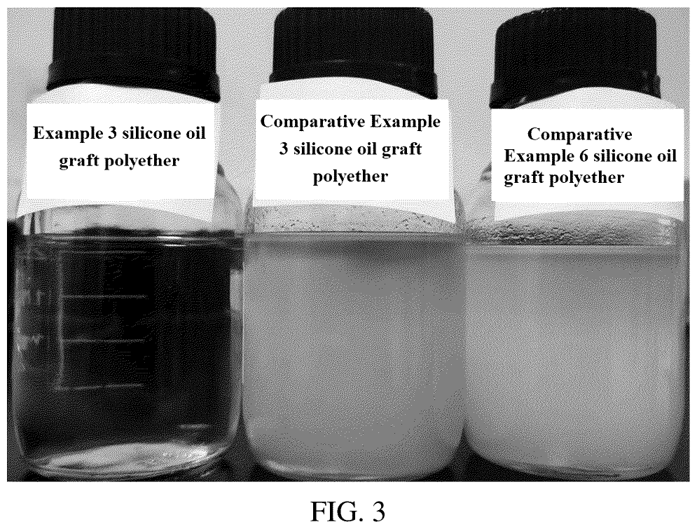

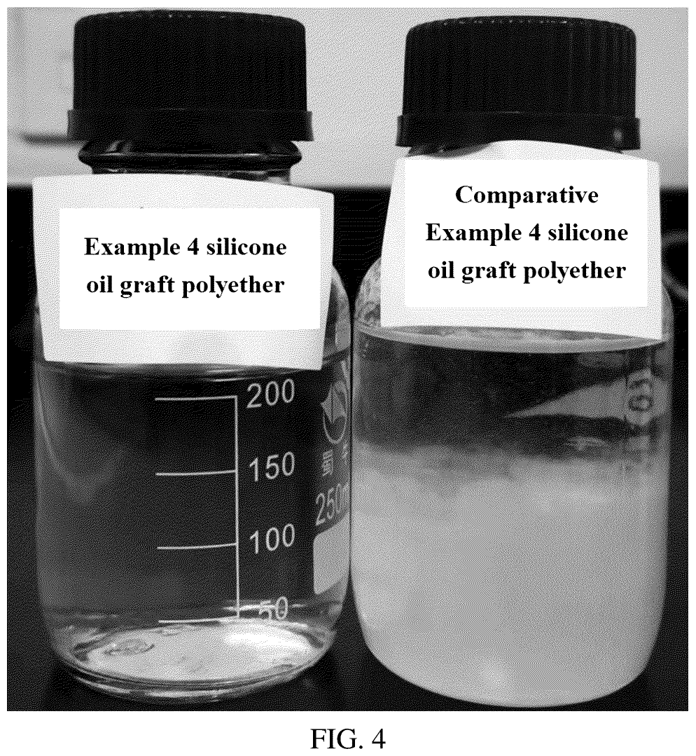

Synthesis process: putting the measured allyl alcohol polyoxyethylene ether and hydrogen-containing silicone oil into the reaction vessel, using N2 to replace the air in the reaction vessel, stirring while heating, after the temperature rises to 90° C., keeping it stable at 90° C. for 5 minutes. When the insulation time is up, adding the catalyst chloroplatinic acid and meanwhile turning off the heating, observing and recording the reaction conditions and the highest temperature during the reaction process, and discharging the material after reacting for 30 minutes. Observing the appearance of the finished polyether-modified silicone oil, and testing the surface tension and penetration of the finished polyether-modified silicone oil. The results are shown in Table 2 and FIGS. 1 to 4.

TABLE 2
Performance comparison results of polyether modified silicone oil products

| | | | | | | | Wetting time |
|---|---|---|---|---|---|---|---|
| | Allyl alcohol | | | Maximum | | Surface tension | (25° C., 2‰ |
| | polyoxyethylene | Hydrogenated | Chloroplatinic | temperature | Appearance | (20° C., 1‰ aqueous | aqueous |
| Items | ether (g) | silicone oil (g) | acid solution (g) | (° C.) | (25° C.) | solution, mN/m) | solution, s) |
| Example 1 | 500 | 900 | 1.4 | 130 | Transparent | 22 | 5.5 |
| | | | | | liquid | | |
| Comparative | 500 | 900 | 1.4 | 90 | Milky white, | 52.8 | >300 |
| Example 1 | | | | | layered | | |
| Example 2 | 500 | 603 | 1.1 | 125 | Transparent | 22.5 | 3.6 |
| | | | | | liquid | | |
| Comparative | 500 | 603 | 1.1 | 90 | Milky white, | 53.4 | >300 |
| Example 2 | | | | | layered | | |
| Comparative | 500 | 603 | 1.1 | 90 | Milky white, | 53.1 | >300 |
| Example 5 | | | | | layered | | |
| Example 3 | 500 | 176 | 0.68 | 121 | Transparent | 23.6 | 12.6 |
| | | | | | liquid | | |
| Comparative | 500 | 176 | 0.68 | 90 | Milky white, | 57.6 | >300 |
| Example 3 | | | | | layered | | |
| Comparative | 500 | 176 | 0.68 | 90 | Milky white, | 56.7 | >300 |
| Example 6 | | | | | layered | | |
| Example 4 | 500 | 118 | 0.62 | 115 | Transparent | 24.8 | 25.9 |
| | | | | | liquid | | |
| Comparative | 500 | 118 | 0.62 | 90 | Layering, | 59.2 | >300 |
| Example 4 | | | | | solid | | |
| | | | | | precipitation | | |

It can be seen from Table 2 and FIGS. 1 to 4 that the allyl alcohol polyoxyethylene ether with the same raw material ratio and the same molecular weight is used, and the same dosage of chloroplatinic acid catalyst and hydrogen-containing silicone oil are used to synthesize polyether-modified silicone oil. The polyether-modified silicone oil products synthesized by the allyl alcohol polyoxyethylene ether prepared in Examples 1 to 4 are all transparent liquids, while the polyether-modified silicone oil products synthesized by the allyl alcohol polyoxyethylene ether prepared in Comparative Examples 1 to 6 are all milky white and stratified, indicating that the allyl alcohol polyoxyethylene ether prepared by the present disclosure can completely react with the hydrogen-containing silicone oil to form a transparent liquid, while the Comparative Examples 1 to 6 are stratified due to incomplete reaction and are milky white non-uniform solutions. It can also be seen from the maximum temperature of the reaction process that the maximum temperature of the reaction process of the allyl alcohol polyoxyethylene ether of the present disclosure is above 115° C., indicating that a large amount of reaction heat is generated to increase the overall material temperature, while the maximum temperature of the reaction process of the allyl alcohol polyoxyethylene ether of Comparative Examples 1 to 6 is 90° C. at the beginning, indicating that the reaction heat is not obvious, and there is basically no reaction, resulting in no temperature rise. The surface tension of the polyether-modified silicone oil prepared in Examples 1 to 4 is significantly lower than that in Comparative Examples 1 to 6, indicating that its surface activity is greatly improved compared with that in Comparative Examples 1 to 6 (the lower the surface tension, the stronger the surface activity); in terms of wetting time, the polyether-modified silicone oil synthesized using the allyl alcohol polyoxyethylene ether prepared in Examples 1 to 4 is also greatly shortened than the polyether-modified silicone oil synthesized using the allyl alcohol polyoxyethylene ether prepared in Comparative Examples 1 to 6. The wetting time of the polyether-modified silicone oil synthesized in Comparative Examples 1 to 6 exceeds 5 minutes and does not have a significant wetting force. The wetting time of the polyether-modified silicone oil synthesized using the allyl alcohol polyoxyethylene ether prepared in Examples 1 to 4 is less than 30 seconds. In summary, the allyl alcohol polyoxyethylene ether prepared by the preparation method of the present disclosure can be well applied to the synthesis of polyether-modified silicone oils in the fields of high-end coatings and the like.

The above-mentioned embodiments are only preferred embodiments of the present disclosure and cannot be used to limit the scope of protection of the present disclosure. Any non-substantial changes and substitutions made by technicians in this field on the basis of the present disclosure shall fall within the scope of protection required by the present disclosure.

What is claimed is:

1. A skeleton supported catalyst, wherein the skeleton supported catalyst is a catalyst loaded with barium oxide, potassium oxide, and yttrium oxide within a copper skeleton; wherein, a weight percentage of the copper skeleton in the skeleton supported catalyst is 70-90%, and a ratio of amount of barium, potassium, and yttrium elements is 1:0.02-0.08:0.01-0.04.

2. The skeleton supported catalyst of claim 1, wherein loading the barium oxide, the potassium oxide, and the yttrium oxide into the copper skeleton, comprising:
Step A: activating aluminum copper alloy in potassium hydroxide solution for 20-28 hours to dissolve aluminum in the potassium hydroxide solution, then filtering and washing to obtain the copper skeleton;
Step B: putting the copper skeleton into a barium hydroxide aqueous solution at 60-70° C., slowly stirring and cooling to 35-45° C., causing the barium hydroxide to supersaturate and precipitate, filtering copper skeleton particles with barium hydroxide precipitate, and calcining the copper skeleton particles at 700-800° C. for 2-4 hours to obtain the copper skeleton loaded with barium oxide;
Step C: immersing or pouring the copper skeleton loaded with barium oxide in a mixed solution containing the potassium hydroxide and yttrium nitrate for 2-5 minutes, after filtration, calcining the copper skeleton at 400-500° C. for 2-4 hours, after cooling, loading the barium oxide, the potassium oxide, and the yttrium oxide into the copper skeleton.

3. The skeleton supported catalyst of claim 2, wherein in Step A, a weight ratio of copper to aluminum in the aluminum copper alloy is 1:2-4; a mass concentration of the potassium hydroxide solution is 25-35%.

4. The skeleton supported catalyst of claim 2, wherein particle sizes of the aluminum copper alloy in step A and the copper skeleton particles in Step B are both 200-1000 μm.

5. The skeleton supported catalyst of claim 2, wherein in Step B, a mass concentration of the barium hydroxide aqueous solution is 15-20%.

6. The skeleton supported catalyst of claim 2, wherein in Step C, a mass concentration of the potassium hydroxide in the mixed solution is 20-30%, and a mass concentration of the yttrium nitrate is 20-30%.
